(19) United States
(12) Patent Application Publication
(10) Pub. No.: US 2008/0140583 A1
(43) Pub. Date: Jun. 12, 2008

(54) Systems and methods for managing investment supply and demand

(75) Inventors: Pauline Lai, North York (CA); A. William Hopton, Toronto (CA); Raff Bruno, Maple (CA); Glen Martin, Markham (CA); Nancy Mcgouran, Richmond Hill (CA); Branimir Kralj, Toronto (CA); Alexandra Dascalu, Richmond Hill (CA)

Correspondence Address: ROPES & GRAY LLP, PATENT DOCKETING 39/41, ONE INTERNATIONAL PLACE, BOSTON, MA, 02110-2624, US

(73) Assignee: The Manufacturers Life Insurance Company, Toronto (CA)

(21) Appl. No.: 11/635,216

(22) Filed: Dec. 6, 2006

(51) Int. Cl. G06Q 40/00

(52) U.S. Cl. 705/36 R

(57) ABSTRACT

The invention relates to methods and systems for allocating investment opportunities generated by a financial services company among liability segments within the financial services company, for predicting future gaps between forecasted supply of investment opportunities and demand for them, for providing originators of investment opportunities with information to help determine an investment's value relative to company targets for similar investments, and for providing information to compare the company's target asset mixes with actual asset mixes.

### BACKGROUND OF THE INVENTION

A large financial services company typically divides its activities among various segments which are managed somewhat independently. The segments may be business groups or divisions within a single corporate entity, they may be subsidiaries of a common parent company, or they may be otherwise affiliated with one another. Some segments, referred to herein as “liability segments,” focus on the sale of financial products that obligate the financial services company to future payments to purchasers of the products. For example, the sale of an insurance policy obligates the company to pay the purchaser, i.e., the insured, for losses covered by the insurance policy. The sale of an annuity obligates the financial services company to pay the purchaser annuity payments.

The revenue generated by the sale of these products, by itself, is insufficient to cover these obligations, much less to generate a profit for the company. To cover this potential shortfall and to generate a desired profit margin, the liability segments must invest the revenue generated from the sale of financial products. The investments must be made strategically to meet the risk tolerances of the financial services company, and in some cases, constraints set forth in government regulations. This need for a liability segment to invest its working capital, i.e. the funds it generates from the sale of products and return on other investments less its payment obligations, within predetermined constraints, is referred to herein as “investment demand.” Any particular asset or deal that a liability segment may invest in, but has not yet done so, is referred to herein as an “investment opportunity.” The body of investment opportunities available to a company to allocate among its liability segments is referred to herein as “investment supply.”

Some financial services companies satisfy the investment demand of their liability segments by having each individual liability segment's investments managed by a portfolio manager who is responsible for making all investment decisions relating to the segment. For example, the portfolio manager may decide to purchase investments from third parties via public stock, bond, and commodity exchanges in the amount required by the segment. Other financial services companies satisfy at least a portion of the investment demand of the liability segments by originating their own investment opportunities through “asset origination groups” within the company. Such self-originated investment opportunities include, for example, private bonds, private equity and mortgages. The liability segments can invest all or a portion of their working capital by funding these self-originated investment opportunities. Financial services companies that use asset origination groups may originate an investment opportunity that is in an amount that is too large for a single liability segment to fund, and it may be an investment that is desirable for many of the company's liability segments. In this case, the liability segments are effectively competing for a share of the investment opportunity.

### SUMMARY OF THE INVENTION

To address these issues, such financial services companies may define a business process to allocate portions of investment opportunities to several liability segments. Similar allocation processes may be employed to allocate opportunities to invest in assets originated and distributed by third parties, such as public stock, public bonds, and real estate. A need exists in the art for methods and systems for managing the allocation of a company's supply of investment opportunities among a plurality of liability segments in the company, each having a varying investment demand. In part to address this need, systems and methods are presented herein for carrying out one or more of the following functions:
Efficiently and fairly allocate a financial service company's supply of investment opportunities (both self-originated and third party) among its liability segments.
Predict for liability segments in the company a difference or gap, over a future period, between forecasted investment demands of those liability segments and the company's forecasted supply of investment opportunities that may be employed to at least partially satisfy that demand.
Calculate and provide information to compare individual investment opportunities' attributes with target investment attributes developed for the company, and
Compare each liability segment's (and the company's) target asset mix (the total assets broken down by asset type, term to maturity, rating and industry sector) with its actual asset mix.

In one aspect, the invention relates to a computer-implemented method for allocating a yet to be funded investment opportunity, such as a mortgage, private loan, or private equity deal, among a plurality of segments of the company. The computer-implemented method includes receiving investment demand data for each of the plurality of liability segments. The investment demand data for a liability segment is broken down into a number of demand components.

As indicated above, a liability segment must invest its working capital according to determined return objectives, risk tolerances, and other constraints. For example, most liability segments are required to diversify their investments among investment opportunities with different asset types, and among investment opportunities with different attributes within each asset type. In addition, as the liabilities incurred by liability segments mature over a period of time, liability segments typically are required to invest in investment opportunities with varying terms to maturity or average life values. Average life may be calculated as a weighted average time to the receipt of all future cash flows. The profile of the cash flows generated by investing in those opportunities should be similar to the profile of the cash flows required to be paid out by a given liability segment. Finally, as the liability segments expect income generated from future sale of products and future investment income, the liability segment will have different levels of investment capital to invest at different times. As working capital is preferably invested as soon as it is available such that it does not stand idle, liability segments aim to make investments at different times in the future. These desired investment dates are referred to herein as “target fill dates” or “target fill months”. In one embodiment, each combination of liability segment, currency, asset type, term, and investment date constitutes a demand component.

Based at least in part on the demand data received for the liability segments, a set of the demand components is identified to which the investment opportunity is to be allocated. For example, in one embodiment, demand components are selected that correspond to the same asset type as the investment opportunity. Additionally, demand components may be selected that have terms that correspond to either the term to maturity or the average life of the investment opportunity. In one embodiment, the demand components are defined for a specific, finite set of term values with associated term tolerances, so demand components are selected if the term or average life of the investment falls within a range defined for each of the term values in the finite set. In still another embodiment, demand components are constrained to invest only in investment opportunities having at least a minimum acceptable rating or a minimum acceptable spread. In this embodiment, the demand components identified for the investment opportunity to be allocated among have minimum acceptable ratings or spreads that are met or exceeded by the investment opportunity.

Next, the method includes determining a suggested allocation of the investment opportunity among the set of demand components based at least in part on constraints (e.g., maximum and minimum investment per liability segment values) associated with each of the demand components. In another embodiment, the investment opportunity may be allocated among the identified demand components based on constraints associated with the investment opportunity. For example, some investment opportunities may not be allocated among more than or less than a predetermined number of liability segments. The suggested allocation may be based on the relative demands of the demand components or based on priorities associated with the demand components.

The suggested allocation is then displayed to a user. In one implementation, the user may then alter the suggested allocation. For example, the user may select additional demand components to which the investment opportunity may be allocated. In one implementation, the user's alterations need not meet the constraints associated with the demand components. For example, the user may add demand components based on a currency that does not match the currency of the investment opportunity. In such cases, a user may also enter information about a currency swap or other derivate contract used to hedge against risks associated with violating the constraints. After the user is finished with any alterations, the allocations are stored. Then at the funding date of the investment opportunity, the liability segments associated with the demand components to which the investment opportunity was allocated fund the investment according to the stored allocation.

In various embodiments, the method includes receiving one or more data feeds, including an investment opportunity supply data feed and a liability segment demand data feed.

In a second aspect, the invention relates to a computer readable medium encoding instructions for causing a computer to carry out one or more of the methods described above. In another aspect, the invention relates to a system for allocating investment opportunities originated by a company among liability segments of the company. The system includes a database for storing investment demand data for each liability segment of a company and allocation constraints which may be applicable to groups or classes of investment opportunities, to specific liability segments or demand components, and/or to specific investment opportunities. The system also includes an allocation program for identifying a set of demand components to which the investment opportunity is to be allocated based at least in part on the demand data stored in the database. The allocation program determines a suggested allocation of the investment opportunity among the set of demand components. In various embodiments, the allocation program also stores an actual allocation of the investment opportunity to the database. In addition, the system includes a graphical user interface for displaying the suggested allocation to a user and enabling the user to modify the suggested allocation.

In a fourth aspect, the invention relates to a computer-implemented method for allocating a forecasted investment supply among a plurality of segments of a company. In one embodiment, the forecasted investment supply is a forecasted aggregated amount of expected future investment opportunities. The method includes receiving investment demand data for the plurality of segments and identifying a set of demand components to which the forecasted investment supply is to be allocated based at least in part on the demand data. At least some of the demand components correspond to at least one of the segments of the company.

The method further includes determining a projected allocation of the forecasted investment supply among the demand components based at least in part on allocation constraints. The allocation constraints may be associated with the various demand components and or groups or classes of investment opportunities. Based on the projected allocation, the method determines a projected set of investment demand gaps for at least one of the segments of the company.

In a fifth aspect, the invention relates to a system for managing investment supply and demand. The system includes a common graphical user interface for interacting with a number of investment management tool computer-implemented processes. In particular, the system includes one or both of a computer-implemented process that outputs a suggested allocation of yet to be funded investment opportunities among a plurality of segments of a business and a computer-implemented process that forecasts future gaps in expected investment supply and demand for a second plurality of liability segments of the company. The system also includes one or both of a computer-implemented process that analyzes proposed deals and outputs a comparison of a proposed deal with data to determine the relative value of the deal to the company and a computer-implemented process that outputs data indicating the mix of assets owned by various segments of the company in comparison to target asset mix goals. In one embodiment, the computer-implemented process incorporated into the system share a common database.

### BRIEF DESCRIPTION OF THE DRAWINGS

The foregoing discussion will be understood more readily from the following detailed description of the invention with reference to the following drawings:

FIG. 1 is a block diagram of a system for allocating investment supply among liability segments of a financial services company, according to an illustrative embodiment of the invention;

FIG. 2 is a schematic diagram of a database included in the system of FIG. 1, according to an illustrative embodiment of the invention;

FIG. 3 is a flow chart of a method of generating a suggested investment opportunity allocation carried out by the allocation program of the system illustrated in FIG. 1, according to an illustrative embodiment of the invention;

FIG. 4 is a supply list page listing investment opportunities that have either been allocated already or are ready for allocation using the allocation program of the system illustrated in FIG. 1, according to an illustrative embodiment of the invention;

FIGS. 5A-5E are screenshots displayed during the process of entering a new investment opportunity into the system of FIG. 1, according to an illustrative embodiment of the invention;

FIG. 6 is a screen shot of a deal analysis page generated by the allocation program of the system illustrated in FIG. 1, according to an illustrative embodiment of the invention;

FIGS. 7A-7C are screenshots of an investment opportunity allocation page displayed to a user by the graphical user interface of the system illustrated in FIG. 1, according to an illustrative embodiment of the invention;

FIG. 8 is a screen shot of a swap information entry page displayed to user by the graphical user interface of the system illustrated in FIG. 1, according to an illustrative embodiment of the invention;

FIG. 9 is a screenshot of an allocation constraints page displayed to a user by the graphical user interface of the system illustrated in FIG. 1, according to an illustrative embodiment of the invention;

FIGS. 10A-10B are flowcharts of methods of generating gap forecast reports, according to an illustrative embodiment of the invention; FIG. 11 is a screen shot of supply forecast entry page for entering an expected future investment opportunity supply, according to one embodiment of the invention;

FIG. 12 is a screen shot of a gap forecast report generated by the system of FIG. 1, according to an illustrative embodiment of the invention; and

FIG. 13 is a flow chart of a method of allocating investment opportunities using the system of FIG. 1, according to an illustrative embodiment of the invention.

### DESCRIPTION OF AN ILLUSTRATIVE EMBODIMENT

To provide an overall understanding of the invention, certain illustrative embodiments will now be described, including systems and methods for allocating investment opportunities among liability segments of a financial services company. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

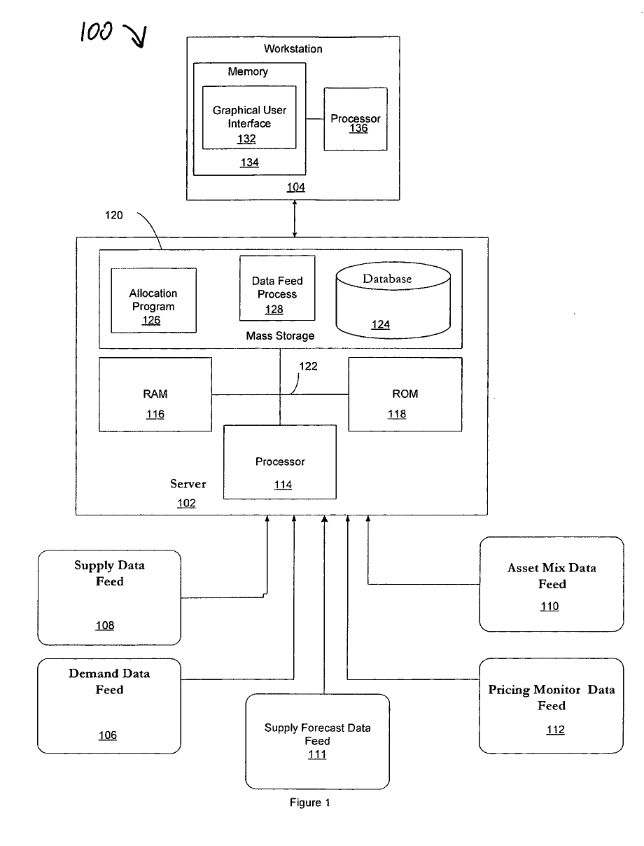

FIG. 1 is a block diagram of a system 100 for allocating investment opportunities among liability segments of a financial services company (the “company”), according to an illustrative embodiment of the invention. The system 100 includes a central server 102 and at least one client workstation 104. The server receives data through a number of data feeds, including a demand data feed 106, a supply data feed 108, an asset mix data feed 110, a supply forecast data feed 111, and a pricing data feed 112. In alternative embodiments, the system 100 may operate on a single stand-alone computer or on multiple servers and/or workstations.

The server 102 is a typical server computer known in the art for client-server applications. The server 102 may be operating, for example, using the WINDOWS 2003 SERVER Operating System, provided by Microsoft Corporation of Redmond, Wash. The server includes a processor 114, random access memory 116, read only memory 118, and a mass data store 120, all connected by a bus 122. The mass data store 120 stores computer readable instructions for the operating system, a database 124, and an allocation program 126 for execution on the processor 114.

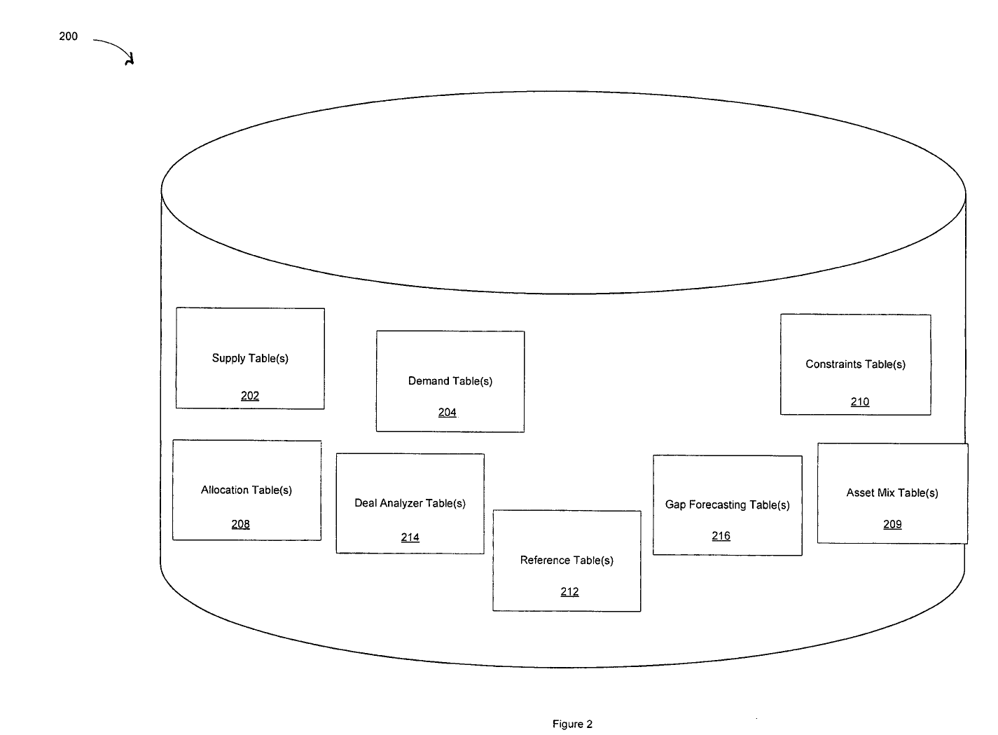

FIG. 2 is a schematic diagram of the database 124 of FIG. 1, according to an illustrative embodiment of the invention. The database 124, in the illustrative implementation, is a SQL Server 2000 Database, offered by Microsoft Corporation, though other database programs would also be suitable for inclusion in the system 100. The database 124 maintains the following sets of data tables: supply tables 202, demand tables 204, allocation tables 208, asset mix tables 209, constraints tables 210, reference data tables 212, deal analyzer tables 214, and gap forecasting tables 216. Each of these tables may store both current and historical data related to the subject matter of the respective tables. While each set of tables is listed above in the plural form, one of ordinary skill in the art would recognize that, depending on any specific database schema, using a singe table, instead, for a particular form of data may be desired for various reasons.

The supply tables 202 store information the system 100 tracks about specific investment opportunities that can be used to satisfy liability segment demand. Examples of these investment opportunities include assets, such as pieces of real property, stocks, and public debt instruments, private debt instruments, private equity instruments and mortgages. The data fields maintained for an investment opportunity vary based on the type of investment opportunity it is. Additional examples of investment opportunities suitable for inclusion in the supply tables 202 include, without limitation, commodities, derivate contracts, and other financial instruments. The investment opportunities may be fixed-income debt instruments and non-fixed income instruments. The investment opportunities may originate from multiple countries and locales, including, for example, the United States, Canada, Japan, Hong Kong, and the United Kingdom.

The demand tables 204 store data related to the investment demand of the liability segments of the company. The demand tables include liability segment demand broken down into demand components. Data fields in the demand tables 204 include liability segment identifier, asset type, currency, term, target fill month, and demand amount. In one implementation, each demand asset type may correspond to more than one supply asset type, as the classification of supply asset types may be more granular in nature than the classification of demand for investment opportunities.

The term data field corresponds to the term of the investment opportunity. In one implementation, the demand tables 204 include two data fields for term, one for the term to maturity of the investment opportunity from its funding date, and a second for the average life of the investment opportunity. Average life, in one implementation, is calculated to be the weighted average time to the receipt of all future cash flows.

In one implementation, the demand tables 204 also include a term tolerance data field for each liability segment. The term tolerance data field stores data indicating an acceptable range around a given specified term the system is willing to accept as matching the term of an investment opportunity.

In one implementation, the demand tables 204 categorize demand based on term labels, which are discrete time frames ranging from one-quarter of a year up to thirty years from the funding date of an investment opportunity. For example, the demand tables 204 may store investment demand for terms of 0.25, 0.5, 1, 2, 3, 4, 5, 6, 7, 8, 9, 10, 15, 20, and 30 years. In this implementation, investment opportunities will have terms to maturity or average life values that do not match precisely with the discrete term labels, so rules are defined in the system about which term labels are considered to correspond with the actual term to maturity or average life of a given investment opportunity. For example, in one implementation, correspondence to a term label is determined based on rounding to the nearest term label. In other implementations, correspondence to term labels is determined based on rounding to the next highest or lowest term label.

The target fill month corresponds to the month in which the liability segment desires to make the investment, and it is this date that is used in determining whether the funding date of an investment opportunity matches the target fill date of a demand component. In one implementation, rules may be defined for liability segments to specify that many target fill dates in addition to the one matching the funding date of the investment on the demand table may be deemed to match an investment opportunity.

The allocation tables 208 store data regarding how the various investment opportunities listed in the supply tables 202 are allocated to the liability segments listed in the demand table 204. As investment opportunities can be reallocated over time, these tables 208 preferably store both current and historical allocation data. The allocation tables 208 preferably also store data indicating how the system 100 recommended each investment opportunity be allocated if it differs from the actual allocation of the investment opportunity.

The constraints tables 210 store data indicating limitations on how investment opportunities can be allocated to the liability segments. In various implementations, constraints can be stored in relation to specific liability segments, specific demand components, specific investment opportunities, and/or groups or classes of investment opportunities. In some implementations, the constraints tables 210 store constraints that apply globally to all demand components or to all investment opportunities. The following is an illustrative and non-limiting list of constraints that may be stored in the constraints table:
The maximum and minimum amounts of an investment opportunity that can be assigned to a liability segment;
The minimum rating accepted by a liability segment for a given asset type;
The minimum spread accepted by a liability segment for a given asset type;
The priority a liability segment has relative to other liability segments;
The difference in term of an investment opportunity in relation to a demand component term a liability segment is willing to accept to match an investment opportunity to the demand component (referred to herein as a “term tolerance”);
Whether to match investment opportunity term to demand component term based on the investment opportunity's term-to-maturity or its average life value.

The asset mix tables 209 store data about actual investments made by the various liability segments of the company, as opposed to the allocations of investment opportunities. The asset mix tables 209 may break the investments data down by liability segment, portfolio, asset type, industry sector, asset term, and asset rating.

The reference tables 212 are miscellaneous data tables maintained by the database 124 for use by the system 100. For example, the reference tables 212 include a table of valid asset types, a table listing the liability segments, a table of portfolios, and a table of ratings. The reference tables 212 may include additional tables as deemed useful for organizing and implementing the database 124.

The gap forecast tables 216 store data relating to the prediction of future differences (gaps) between forecasted supply and demand. The following is an illustrative and non-limiting list of the data that may be stored in the gap forecast tables:
Forecasted supply data for each business area in the company originating investment opportunities, showing the aggregated amounts each business area expects to originate for each asset type, term and target fill month into the future. In one implementation, the forecast is done for 12 months into the future.
Demand data smoothed to offset negative demand amounts in some target fill months with positive demand amounts in other target fill months.
Gap forecast data indicating gaps between investment supply and investment demand for each of the liability segments over varying periods of time, broken down by, for example, asset type, term, and currency.

The Deal Analyzer tables 216 store data relating to the comparison of investment opportunity attributes to target attributes received or calculated by the system 100. The following is an illustrative and non-limiting list of the data stored in the Deal Analyzer tables:
Input factors (e.g. tax rates, interest on capital rates, gross-up factors) used in calculating Return on Capital for an investment opportunity.
Factors used to take into account administration fees and the possibility of loan defaults when calculating net spread from gross spread. The spread may be calculated as the expected yield of an investment opportunity over and above a government bond used as a benchmark.
Comparison data received via the Pricing Monitor feed 112 or calculated by the system for comparing to corresponding attributes of a particular investment opportunity. In one implementation, this comparison data consists of the following comparators calculated for different asset types, average life values, and rating values:
   Target gross spread
   Target net spread
   Target return on capital (using one or more calculation schemes and sets of assumptions, for example the schemes known as MCCSR and RBC)
   Breakeven net spread (e.g., the breakeven return on capital using one or more calculation scheme)
   Historical net spread for recently originated investment opportunities
   Historical return on capital using one or more calculation schemes
   The number of investment opportunities and aggregate investment amounts used to calculate the historical figures
   Target net spread planned in annual planning process
   Target return on capital (using one or more calculation schemes).

Referring back to FIG. 1, the allocation program 126 communicates with the client workstation 104 and the database 124. The allocation program 126, using data stored in the database 124, generates suggested investment opportunity allocations, receives allocation instructions from the client workstation 104 and stores them in the database 124, receives manual entry of new investment opportunities, and generates reports based on requests received from the client workstation 104.

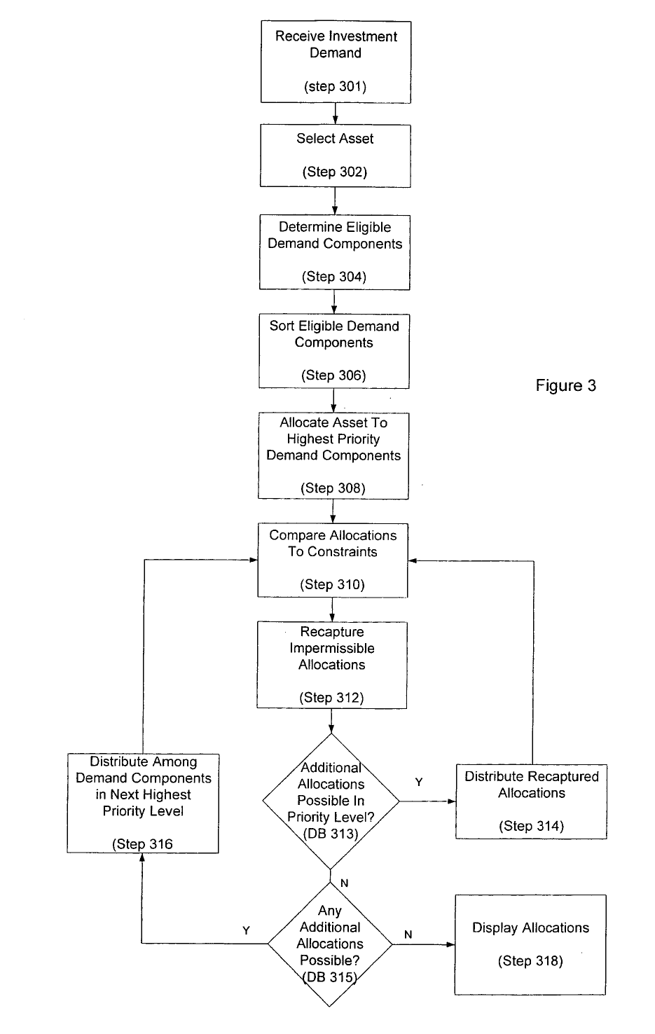

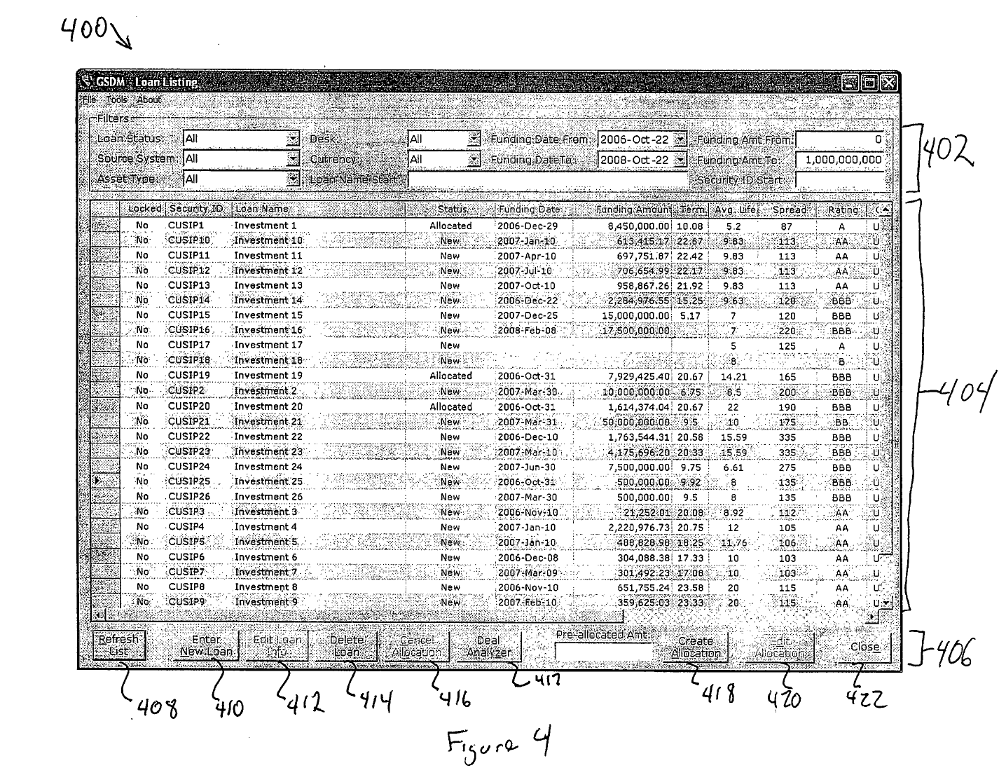

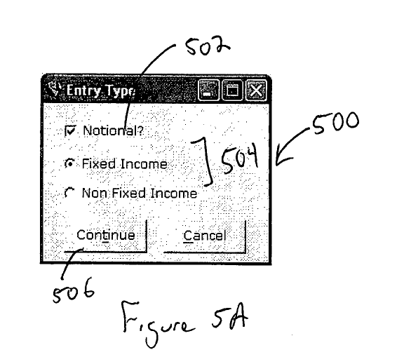

FIG. 3 is a flow chart of a method of generating a suggested investment opportunity allocation 300 (the “allocation method 300”) carried out by the allocation program 126 of the system 100 illustrated in FIG. 1, according to an illustrative embodiment of the invention. The allocation method 300 begins with the system 100 receiving investment demand data for the liability segments of the company (step 301). The demand is broken down into demand components, as described above. The received demand data is stored in the demand tables 204 of the database 124. Next, a user selects an investment opportunity to allocate (step 302) via the workstation 104 from a supply listing page (see FIG. 4).

The allocation program 126 determines a set of eligible demand components from those listed in the demand tables 204 among which to allocate the investment opportunity (step 304). In the illustrative embodiment, the allocation program 126 considers multiple demand components for each liability segment. Generally, for an investment opportunity to be allocatable to a particular demand component, the investment opportunity must have the same asset type, be in the same currency, have a term or average life that matches the term of the demand component within defined tolerance limits, and the funding date of the investment opportunity must match the target fill date of the demand component within defined tolerance limits. These tolerance limits are stored in the constraints tables 210. In addition, the investment opportunity must meet any other constraints for the demand component stored for the corresponding liability segment in the constraints tables 210. For example, the spread and rating of the investment opportunity must meet or exceed the corresponding minimum spread and rating values stored for the liability segment.

In determining whether the term of the investment opportunity matches that of a demand component, the allocation program 126 retrieves term tolerance data from one of the constraints tables 210. For example, assume an investment opportunity has a term of 4.4 years. A 5 year nominal term of a demand component may be defined to match to any investment opportunity term between 4 years and 7.5 years (inclusive), which would include the example of 4.4 years. Similarly, a 3 year nominal term of a demand component may be defined to match to any investment opportunity term between 2 years and 4.5 years, in which case it would also be considered a match for the example of 4.4 years. On the other hand, a 10 year nominal term of a demand component may be defined to match any investment opportunity term values between 7.5 and 12.5 years, in which case it would not be a match for the example investment opportunity. Another liability segment may define the term tolerances more narrowly, so that for that liability segment, a match to a demand component with a nominal 3 year term would require an investment term between 2.5 and 3.5 years, a match to a demand component with a nominal 5 year term would require an investment term between 4.5 and 5.5, and a match to a demand component with a nominal 10 year term would require an investment term between 9.5 and 10.5 years. None of these demand components would be considered a match for the example 4.4 year term investment opportunity. In all of the examples above, the term of the investment opportunity can be interpreted as either the term to maturity or the average life of the investment. The system can also be configured to require both the term to maturity and the average life to fall into tolerance ranges as described above.

After the eligible demand components are selected (step 304), the allocation program 126 sorts the eligible demand components by priority based on priority data stored in the constraints tables 210 (step 306). The investment opportunity is then allocated among the eligible demand components with the highest priority (step 308). The investment opportunity is distributed among the highest priority demand components pro-rated by the demand components' demand amounts. In one implementation, the allocations are rounded to the next lowest multiple of a rounding increment that is stored in the reference tables 212. The allocation program 126 then compares these initial allocations to the constraints stored in the constraint table 210 for the liability segments from which the demand components were derived (step 310).

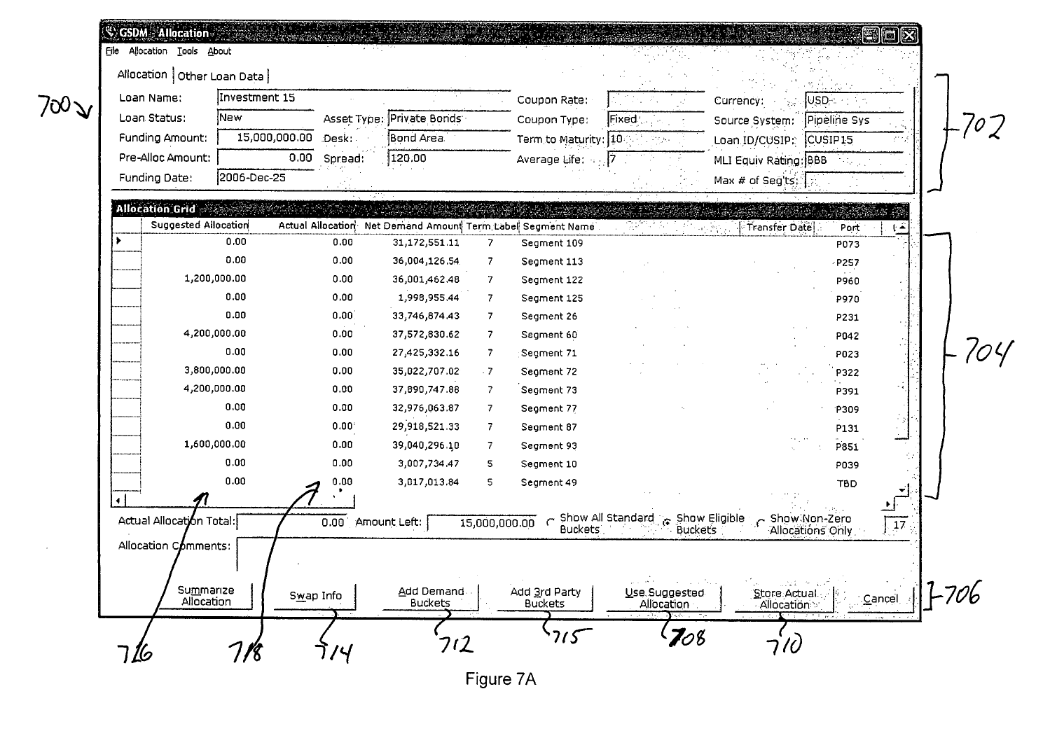

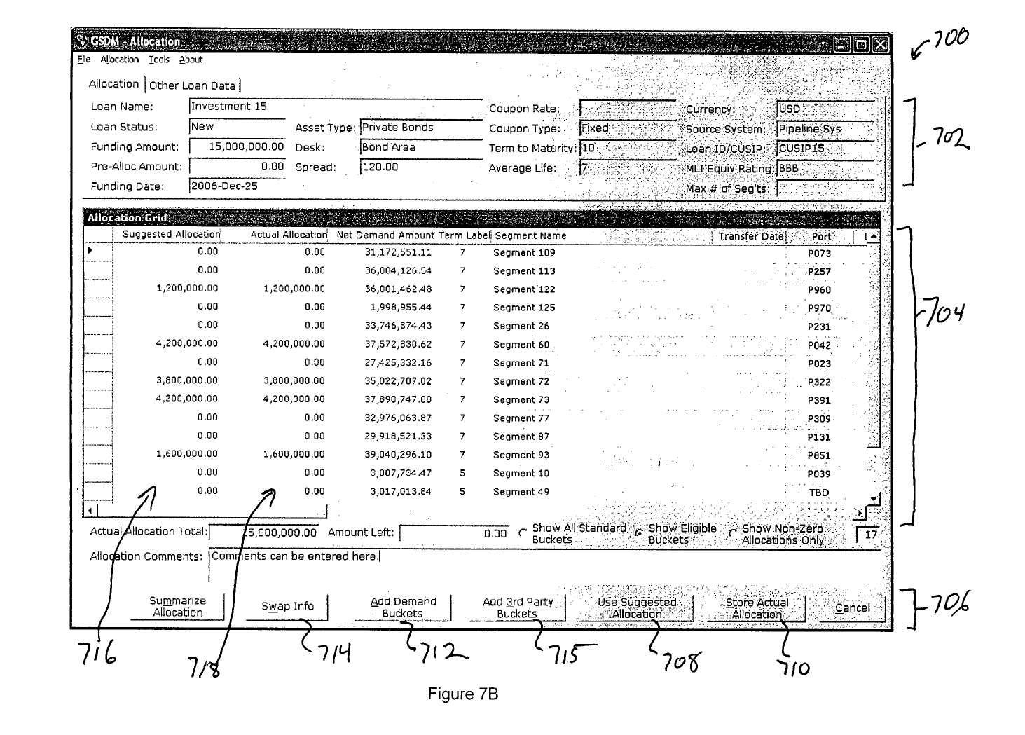

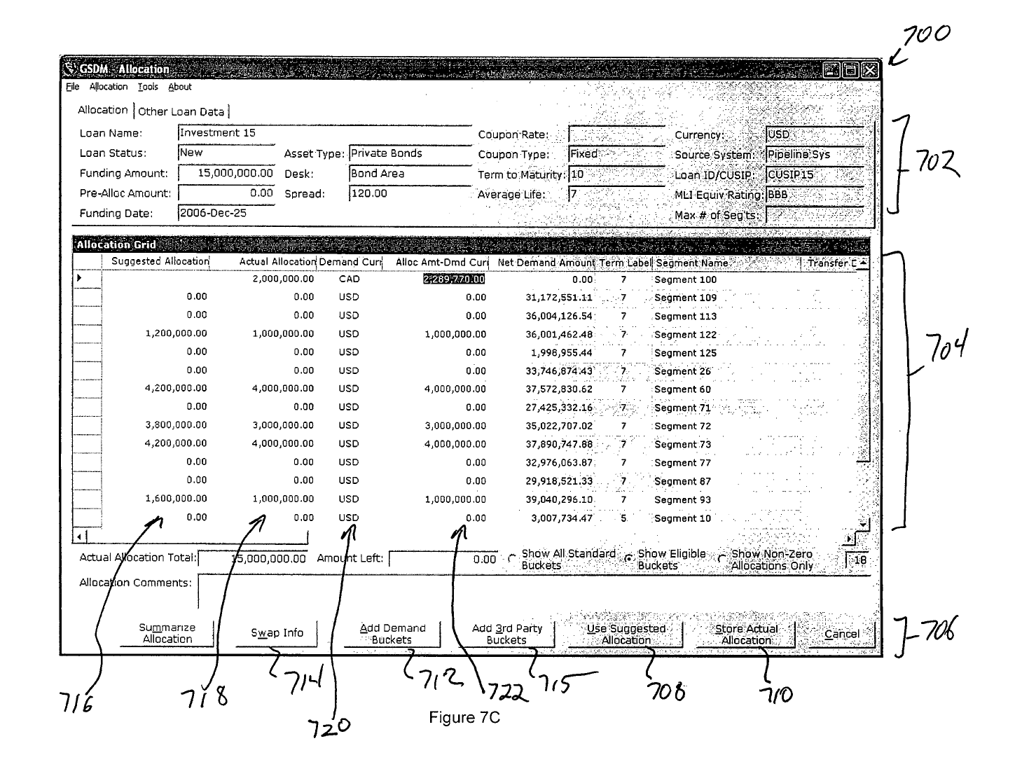

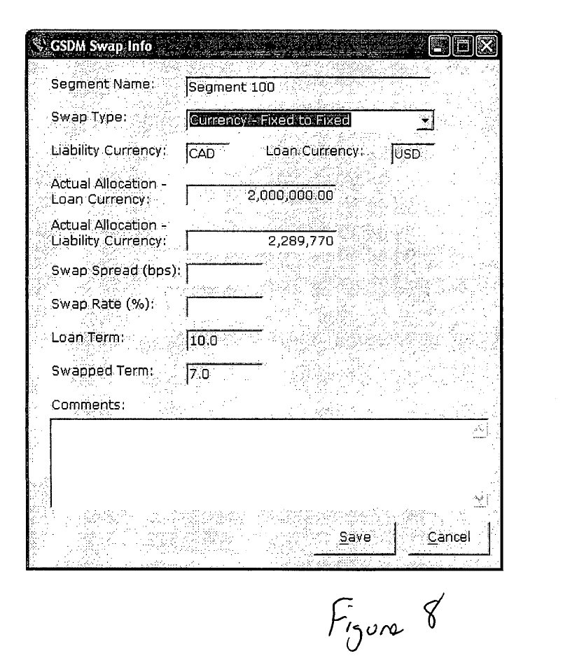

Impermissible allocations are then recaptured (step 312). For example, if the amount allocated to a demand component is less than the minimum allocation amount for its corresponding liability segment, the amount allocated to that demand component is recaptured. Similarly, if the amount allocated to a demand component exceeds the maximum allowed according to one of the constraints tables 210 or if the amount exceeds the total demand for the demand component, the excess amount is recaptured. If allocation of the recaptured amounts to demand components in the highest priority is possible (decision block 313), the recaptured amount is redistributed among these demand components until no more allocations are possible (step 314). The allocation process then continues iteratively in a similar fashion with demand components having lower priorities (step 316) until the investment opportunity has been fully allocated or no more allocations are possible (decision block 315). The allocations are stored in the allocation tables 208 and are communicated to the workstation 104 for output to a user (step 318) (see FIG. 7A).

Alternative allocation processes are also suitable for use by the allocation program 126. For example, in one alternative implementation, instead of an investment opportunity being allocated to higher priority demand components before lower priority demand components, the allocation of an investment opportunity to each demand component is based on a weighted average of the demand of a demand component multiplied by the priority assigned to the liability segment to which it belongs. Similarly, additional constraints can be imposed on the allocation process. For example, a constraint can be set to allocate an investment opportunity to no more than a predetermined number of demand components or segments. This constraint for a maximum number of segments may vary based on asset type, term, currency, and total funding amount.

In another embodiment, mathematical techniques are used to improve the return on capital for the company by altering the amounts suggested for each liability segment.

In still another embodiment, the allocation program 126 can suggest multiple allocations based on multiple possible future business scenarios. For example, the allocation program 126 may allocate a given investment opportunity based on a different set of demand data for the same liability components. Each set of demand data is based on a set of projected business conditions having determined probabilities of occurring. Thus, the user can see the relative effects on the suggested allocation of different business scenarios that result in the different sets of demand data with different probabilities.

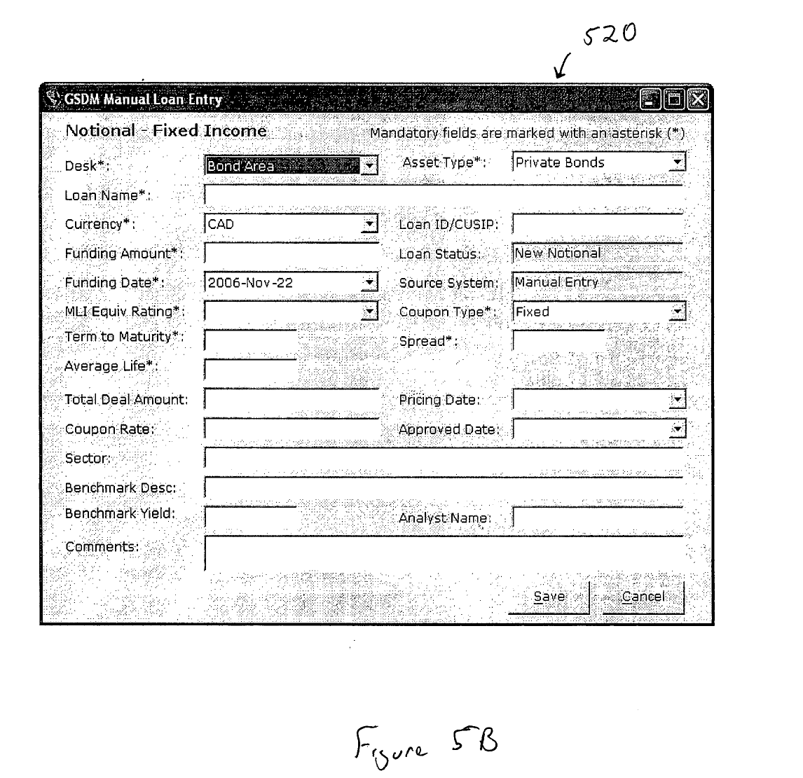

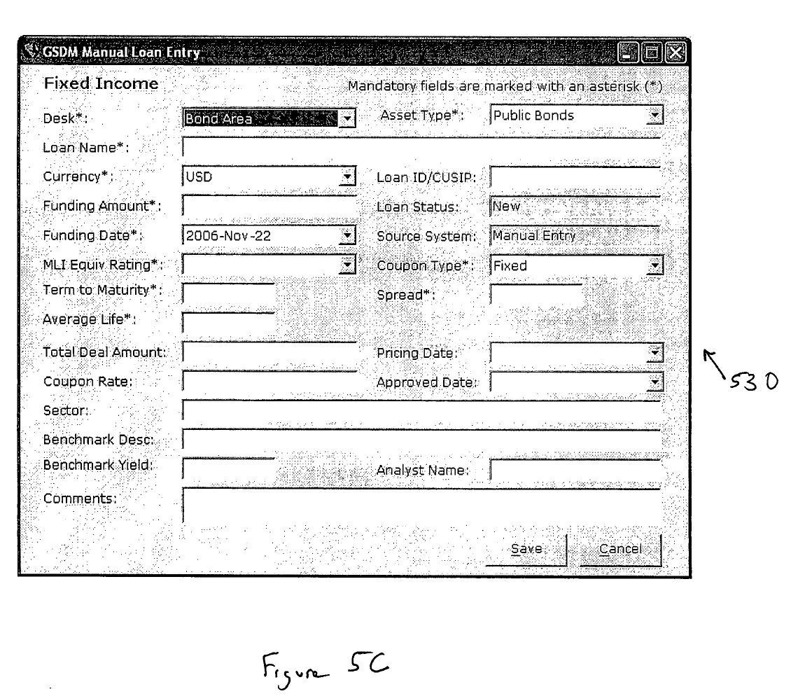

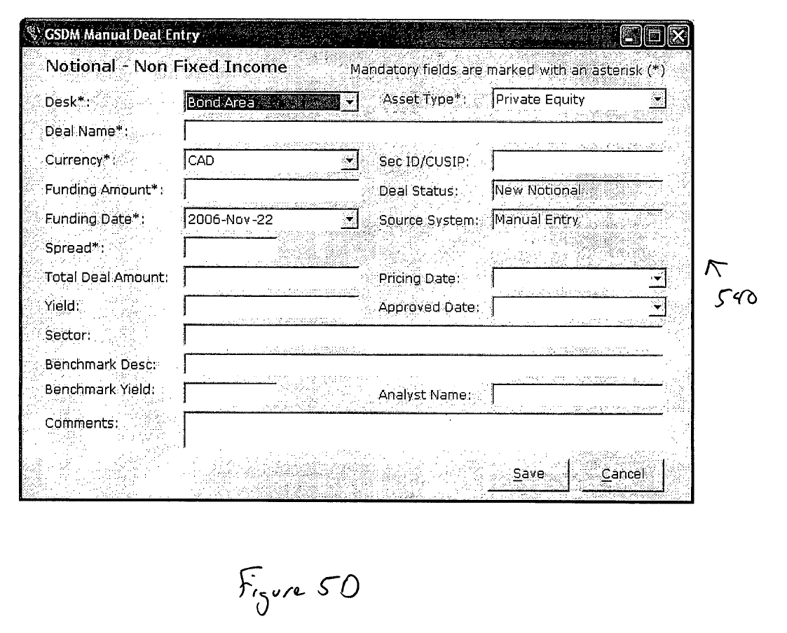

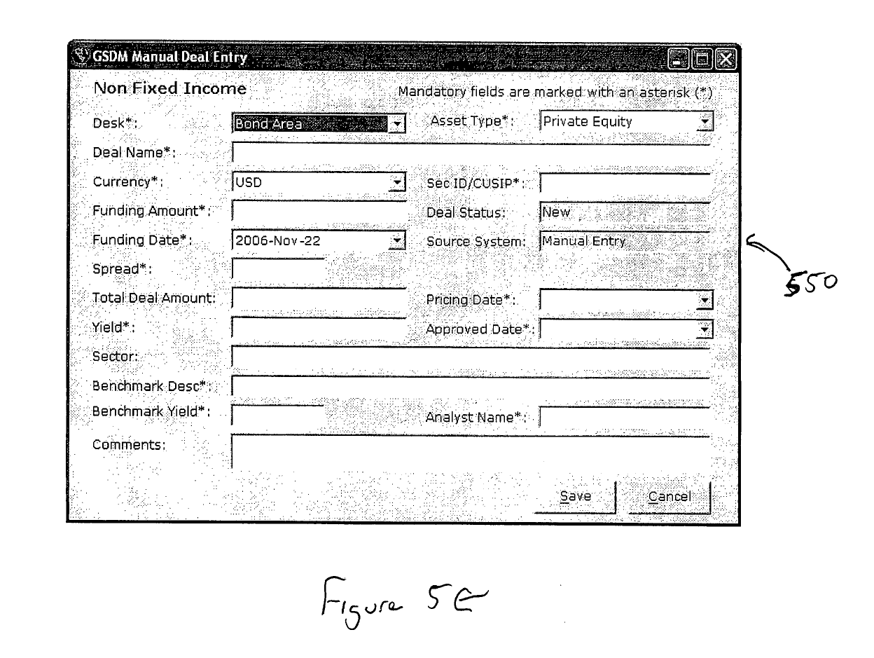

Referring back to FIG. 1, the server 102 includes a data feed process 128 for receiving the data feeds 106, 108, 110, 111, and 112. The data feed process 128 can be implemented as a software component built into the database 124, as part of the allocation program 126, or as a stand-alone software application. The data feeds 106, 108, 110, 111, and 112 can be input into the data feed process 128 on a monthly, weekly, daily, hourly, or real-time basis. The input schedule may also vary by feed type. The data feed process 128 parses a data feed and stores the data included therein in the appropriate tables of the database 124. Additional investment demand and supply data can be input directly into the system through the allocation program 126 via the workstation 104 (see, for example, FIGS. 5A-5E).

The workstation 104 provides a graphical user interface 132 enabling a user to interact with the allocation program 126. The graphical user interface 132 is stored in memory 134 on the workstation in the form of computer readable instructions, which are executed by a processor 136. The graphical user interface 132 can be stored in both volatile and non-volatile storage. In the illustrative implementation, the graphical user interface 132 interfaces with the allocation program 126 according to the .NET framework defined by Microsoft Corporation. FIGS. 4-9, 11, and 12 are screenshots generated by the graphical user interface 132.

As the majority of investment opportunities handled by the system, in this illustrative embodiment, are either mortgages or private debt instruments, the graphical user interface uses the term “loan” to refer generally to an investment opportunity. The word “loan,” in the screen shots only, refers to any type of investment opportunity handled by the system, including real estate and equity.

FIG. 4 is a supply list page 400, listing investment opportunities for allocation among liability segments of the company using the allocation program 126, according to an illustrative embodiment of the invention. The supply list page 400 is used to review investments which have already been allocated, to review the currently available investment opportunities, and to select investment opportunities for editing, deletion, allocation, or re-allocation. The top portion of the supply list page 400 includes a set of filters 402 for narrowing down the list of investment opportunities displayed to a user. For example, the list of investment opportunities can be filtered by status of the investment opportunity, the source of the investment opportunity, the asset type, the currency on which the investment opportunity is based, the rating of the investment opportunity, the date on which the investment opportunity will be funded, the funding amount, the name or partial name of the investment opportunity, or a code identifying a specific investment opportunity. Investment opportunity statuses include “New,” “Allocated,” “Allocated Incompletely,” “Suspended,” “Closed,” and special statuses that distinguish new investment opportunities from “notional” ones that represent either opportunities that are under consideration or hypothetical opportunities. New investment opportunities are those that have yet to be addressed by a user. Investment opportunities with an Allocated Incompletely status have been partially, but not completely allocated. Allocated investment opportunities have been fully allocated. Suspended investment opportunities are those that have been at least partially allocated, but for which data has changed since the last allocation of the investment opportunity. An investment opportunity is Closed if it has been fully funded and its corresponding allocation has been transferred to the corresponding segments. The additional statuses for notional opportunities are “New Notional” (not allocated) and “Allocated Notional” (allocated).

The middle of the supply list page 400 displays a list of investment opportunities 404 that meet the criteria entered into the filters 402 at the top half of the supply list page 400. The data for generating the supply list page 400 is stored in the supply table 202, described in FIG. 2. For each investment opportunity in the list of investment opportunities 404, the supply list page 400 displays the following information: whether the investment opportunity is locked (i.e., it is currently being worked on by another user), the investment opportunity ID, the name of the investment opportunity, the status of the investment opportunity, the investment opportunity funding date, the funding amount, the term of the investment opportunity, the average life of the investment opportunity, the spread of the investment opportunity, and the rating associated with the investment opportunity.

The bottom of the supply list page 400 includes a series of buttons 406 corresponding to a number of actions a user can select. The buttons include a refresh list button 408, an enter new loan button 410, an edit loan button 412, a delete loan button 414, a cancel allocation button 416, a deal analyzer button 417, a create allocation button 418, an edit allocation button 420, and a close button 422.

The bottom of the supply list page 400 also includes a box for entering a pre-allocated amount. This is used when the user has prior knowledge of a particular amount that is to be allocated to a segment for which demand may or may not exist. For example, a portion of some investments may be negotiated to be purchased by a third party. In this case, the user would enter the portion as a pre-allocated amount and use the allocation program to allocate the balance of the funding amount.

The refresh list button 408 refreshes the results of the filters. For example, if a number of users are using the system 100 to allocate investment opportunities, the status of various investment opportunities may change over time. In addition, new investment opportunities may get added to the list 404, or locked by other users. Thus, if a user steps away from the workstation 104 for an extended period of time, pressing the refresh button 406 ensures the list 404 is up to date.

Not all investment opportunities stored in the supply table 202 are received via the supply data feed 108. In addition, investment opportunity originators may wish to evaluate how a new investment opportunity would affect investment demand. The enter new loan process initiated by the enter new loan button 410 enables a user to enter a new real investment opportunity or to enter a new hypothetical investment opportunity for analysis. FIGS. 5A-5E are screenshots displayed during the process of entering a new investment opportunity. FIG. 5A is a screenshot of a new investment opportunity selection page 500. The system 100 allows users to enter new actual investment opportunities and hypothetical investment opportunities to see how those hypothetical investment opportunities might be allocated, and to see how the opportunity's attributes compare to a set of comparison data displayed by the Deal Analyzer function. The user chooses between entering an actual and a hypothetical investment opportunity by setting a notional investment opportunity flag 502 on the new investment opportunity selection page 500. Then the user can select between creating a fixed income investment opportunity and a non-fixed income investment opportunity by selecting one of a pair of corresponding radio buttons 504. Fixed income investment opportunities include, without limitation, mortgages, private debt, and public debt. Non-fixed income investment opportunities include, without limitation, timber, agricultural, oil, gas, and other natural resource investments, private equity investments, real estate investments, and investments in affordable housing. The user continues the process of generating the new investment opportunity by selecting the continue button 506.

FIG. 5B is a screenshot of a notional fixed income investment opportunity entry page 520, according to an illustrative embodiment of the invention. Data fields marked with asterisks are mandatory. Fields in gray are populated automatically and cannot be edited. Using this page 520, a user can enter a new hypothetical or notional fixed income investment opportunity into the system 100. FIG. 5C is a screenshot of an actual fixed income investment opportunity entry page 530, according to an illustrative embodiment of the invention. Through this page 530, a user can manually enter a new fixed income investment opportunity into the system 100.

FIG. 5D is a screen shot of a notional non-fixed income investment opportunity entry page 540, according to an illustrative embodiment of the invention. A user can enter a hypothetical or notional non-fixed income investment opportunity using this page 540. FIG. 5E is a screenshot of an actual non-fixed income investment opportunity entry page 550, according to an illustrative embodiment of the invention. A user can use this page 550 to enter an actual new non-fixed income investment opportunity into the system 100. In both pages 540 and 550, asterisks mark required data fields. Term is not always a required field for non-fixed income investment opportunities, as many non-fixed income opportunities do not have defined terms. Thus in matching such investment opportunities to demand components, term matching can frequently be omitted. On the notional non-fixed income investment opportunity entry page 540, there are fewer required fields than on the actual non-fixed income investment opportunity entry page 550 to simplify the process of evaluating hypothetical investment opportunities.

For some fixed income investment opportunities and some non-fixed income investment opportunities, there are multiple funding dates to take into consideration. For example, a loan might have multiple tranches with different funding dates, or have funding rounds that are conditional on the completion of milestones. To accommodate investment opportunities with multiple funding rounds, the system 100 operates in the following fashion. First, a user enters the total value (i.e., the total of all funds to be distributed or expended) of the investment opportunity as a notional investment opportunity. The user then requests a suggested allocation of the notional investment opportunity (for example, according to the allocation method 300). Next, the user enters a separate actual investment opportunity for each round of funding associated with the investment opportunity and allocates each actual investment opportunity pro-rata according to the suggested allocation for the notional investment opportunity corresponding to the full investment opportunity. Allocating to the same demand components in the same proportion as a previously-completed allocation can be achieved, in one implementation, by selecting two investments in the supply list page 400. First, the user selects an already-allocated investment to be used as a model. Then, holding down the Ctrl key (as is the Microsoft standard method for selecting multiple items from a list), the user selects the investment to be allocated. Finally, the user clicks create allocation button 418, thereby allocating the second selected investment in the same proportions as the first selected investment.

In some instances, the details of an investment opportunity change before their funding date. For example, funding dates and funding amounts may change. While a user, in some implementations may wish to directly edit investment opportunities received into the system via a data feed, such investment opportunities are preferably edited at the original data source, as opposed to through the system 100. If the investment opportunity was originally entered directly into the system as opposed to coming from a feed from another database, or if the user decides to edit an investment opportunity received via a data feed, a user may utilize the edit investment opportunity functionality of the user interface 132 by selecting the investment opportunity in question and activating the edit loan button 412. As a result, the graphical user interface 132 displays a page similar to that used for investment opportunity entry for the asset type of the selected investment opportunity. For example, if the selected investment opportunity is a notional fixed income investment opportunity, the graphical user interface 132 displays a page similar to the notional fixed income investment opportunity entry page 520.

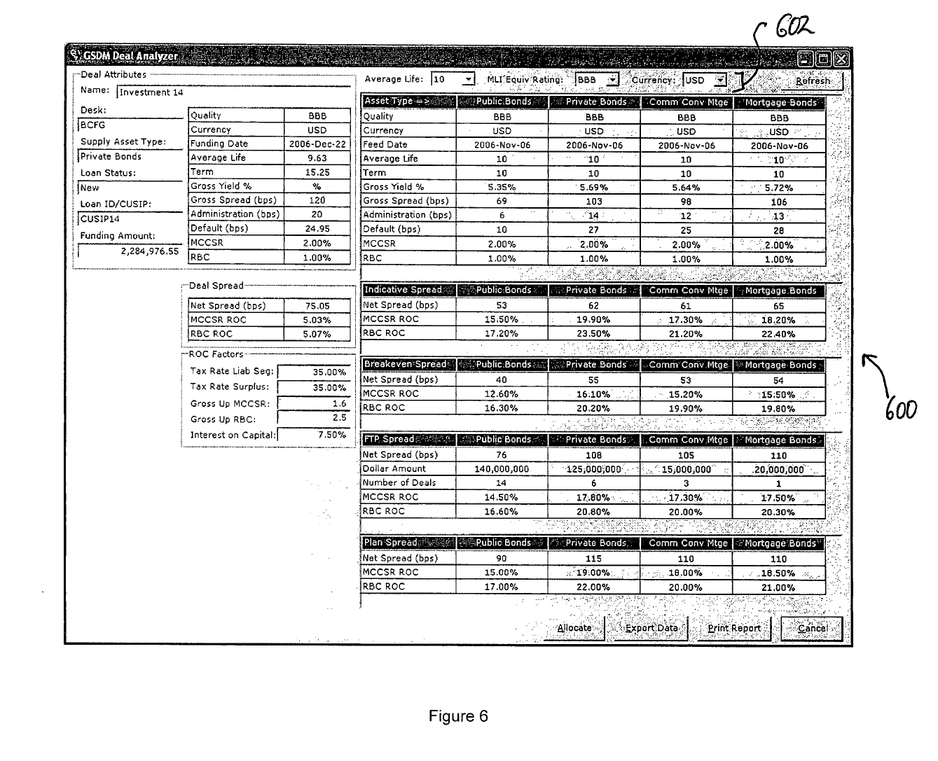

In one implementation, the investment opportunity list page 400 and the pages for entering new investment opportunities 520, 530, 540, and 550, include a button for causing the allocation program 126 to generate a deal analysis page for a selected investment opportunity or new investment opportunity being entered, respectively. FIG. 6 is a screen shot of one such deal analysis page 600 generated by the allocation program 126, according to an illustrative embodiment of the invention. The deal analysis page 600 displays a comparison of the investment opportunity in question in relation to other investment opportunities, as stored in the Deal Analyzer tables 216, described previously, which contain data that may, in part, come from the Pricing Monitor feed 112.

The deal analysis page 600 calculates, if necessary, and displays to a user the gross yield of the investment opportunity, the gross spread of the investment opportunity, costs associated with the investment opportunity, the net spread of the investment opportunity (calculated as the gross spread minus expected effect of investment default and administration) and the return on capital expected on the investment opportunity. The particular set of investment opportunities used for comparison to the selected investment opportunity can be selected using filters 602 located at the top of the deal analysis page 600. In the illustrative deal analysis page 600, the selected investment opportunity is compared against other investment opportunities with a 10-year term, having a BBB rating, in US dollars, which are values chosen by the system as matching most closely the attributes of the investment opportunity. The deal analysis page 600 allows for other comparison data to be viewed also. In addition to displaying the analysis on the workstation 104, the allocation program 126 can export the analysis to another application or print the data to a printer.

Referring back to FIG. 4, the create allocation button 416, when activated, initiates the allocation of an investment opportunity to eligible demand components. FIGS. 7A-7C are screenshots of an investment opportunity allocation page 700 displayed to user by the graphical user interface 132, according to an illustrative embodiment of the invention. FIG. 7A is screenshot of the investment opportunity allocation page 700 as initially displayed to a user upon activation of the create allocation button 416. A subset of data related to the investment opportunity being allocated is displayed in an upper portion 702 of the investment opportunity allocation page 700. The middle portion 704 of the page includes a list of demand components from the demand table 204 of the database 100 to which the allocation program 126 has determined the investment opportunity can be allocated, for example, as part of the allocation method 300. A suggested allocation of the selected investment opportunity, determined according to the allocation method 300, described above, is displayed in the middle portion 704, along with information from the demand table 204 about each of the eligible demand components.

The bottom portion 706 of the investment opportunity allocation page includes a series of buttons for user activation. The bottom portion 706 includes a use suggested allocation button 708, a store actual allocation button 710, an add demand bucket button 712, a swap info button 714 and an add 3^{rd} party buckets button 715. If the user is for the most part satisfied with the suggested allocation, the user can activate the use suggested allocation button 708 to transfer the suggested allocations from a suggested allocation column 716 of the middle portion 704 to an actual allocation column 718, as seen in FIG. 7B. The suggested allocations can be overridden by manually selecting an allocation value in the actual allocation column 718 and entering a replacement value. In one implementation, the manually entered value must adhere to the allocation constraints stored for the corresponding demand component. Failure to meet such constraints results in the display to the user of an error message. Alternatively, manual overrides of allocations are permissible regardless of the constraints.

In addition to changing values of the suggested allocations, a user can override the eligibility analysis conducted by the allocation program 126, for example at step 304 of the allocation method 300, by adding an additional demand component for allocating the investment opportunity to by activating the add demand bucket 712 button. The additional demand component may share a currency with the investment opportunity, or it may be based on another currency. By activating the add 3^{rd} party buckets button 715, the user may add demand components for special segments representing 3^{rd} party investors that may have arranged to invest in a portion of the investment opportunity.

FIG. 7C is a screenshot of the allocation page 700 after a demand component has been added to the initial set of demand components identified by the allocation program 126. The additional demand component in the screenshot is based on a different currency (i.e., Canadian dollars) than the investment opportunity being allocated (i.e., U.S. dollars). To accommodate this situation, the graphical user interface 132 displays two additional columns, a currency column 720 and a foreign currency allocation value column 722, in the middle portion 704 of the allocation page 700. The currency column 720 indicates the currency associated with each demand component. The foreign currency allocation value column 722 displays the value of the allocation in terms of the currency of the demand component (i.e., the allocated value multiplied by an exchange rate). The actual allocation column 718 displays the allocation in terms of the underlying currency of the allocated investment opportunity.

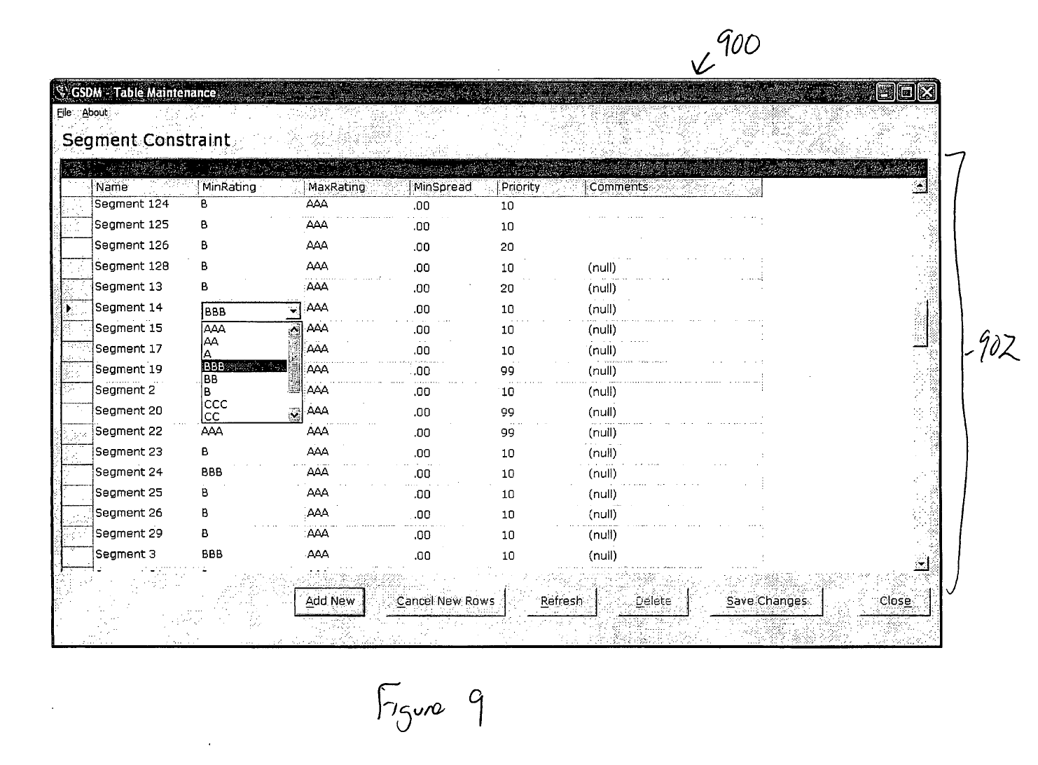

In circumstances in which a user allocates a portion of an investment opportunity based on a first currency to a demand component based on a second currency, the user may enter data about a currency swap entered into by the company to take into the account the potential variation in currency values over the term of the investment opportunity. To enter swap information, the user activates the swap info button 714, bringing up the swap information entry page 800, depicted in FIG. 8. The swap info button 714 can also be used to enter information about other derivate contracts the financial services company intends to purchase or sell to hedge their investment in the investment opportunity.

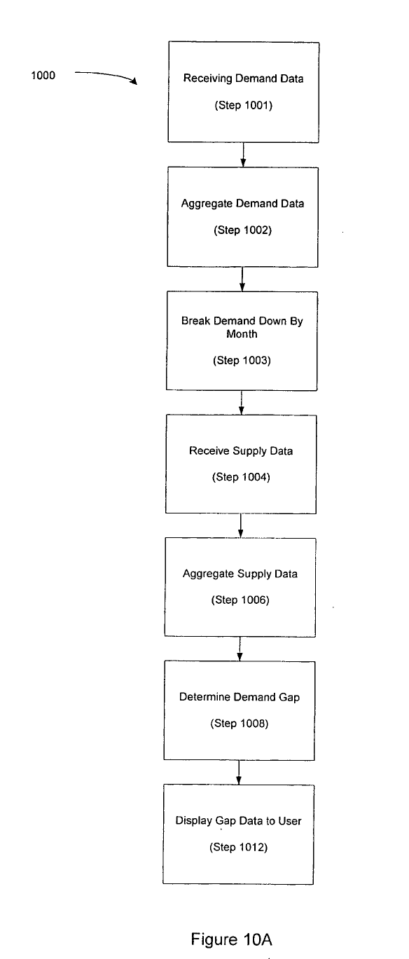

As mentioned above, the allocation program creates suggested allocations based on constraints associated with each demand component. FIG. 9 is a screenshot of an allocation constraints page 900, according to an illustrative embodiment of the invention, that lists the constraints applied to each demand component in the demand table 204. The allocation constraints page 900 provides a user the ability to review and edit the constraints used by the allocation program 126, provided the user has been given the authority to do so. If the user does not have the authority to do so, this feature will not be available to him or her. Constraints can be adjusted by selecting a cell in a table of constraints 902 displayed on the allocation constraints page 900. The user can then select a new value from a drop down menu or by entering a value manually. Any updates to the constraints are then stored in the constraints tables 210 of the database 124.

In addition to being used for allocating investment opportunities, the allocation program 126 can be utilized to generate reports about investment supply and demand. In one implementation, the allocation program 126 generates reports for on-screen viewing at the workstation 104 via the graphical user interface 132. Alternatively, or in addition, the allocation program 126 generates reports for electronic download, in, for example, comma-separated variable, tab-separated variable, or other format for manipulation and analysis by other programs, such as a spreadsheet application. Illustrative reports include, without limitation, an asset mix by liability segment report, a gross demand by liability segment report, a gross demand by term report, a net demand by term report, a gap forecasting report, an allocation by term report, and an origination entity allocation by term report.

These reports can be used by a user of the system 100 to adjust the constraints for a demand component based. Two reports of particular note include the asset mix report and the “gap forecasting report”. The asset mix report draws data from the asset mix table 209 of the database 124. Via the graphical user interface 132, a user can select a series of parameters for generating the asset mix report using data stored in the asset mix table 209 of the database 124. For example, a user can request the mix of investments a liability segment has invested in by asset type, rating, industry sector and/or term. Data received in the asset mix report can be used to adjust demand levels or constraints for demand components.

The gap forecasting report provides data about expected shortfalls and/or excesses in liability segment investments over a future period. The report can be used to adjust the asset origination objectives of asset origination groups to assist in reducing identified gaps. Similarly, the report can be used to affect the pricing of products sold by asset origination groups. For example, if the report indicates only a small shortfall or an excess of supply in a particular asset type for a particular term and month, the asset origination groups can raise the rates associated with investment opportunities of that asset type, thereby limiting the future supply of that asset type. Similarly, rates for investment opportunities of a given asset type can be reduced to generated increased supply. Preferably, the forecast includes data for the entire financial services company and for each liability segment. In addition, the forecast preferably includes data for, within each liability segment, each asset type, each term, and each desired fill month.

In another embodiment, different scenarios may be created, each with its own set of demand data and supply forecast data. Each scenario may be assigned a probability, so that a probabilistic distribution may be derived for the gap over a given planning horizon.

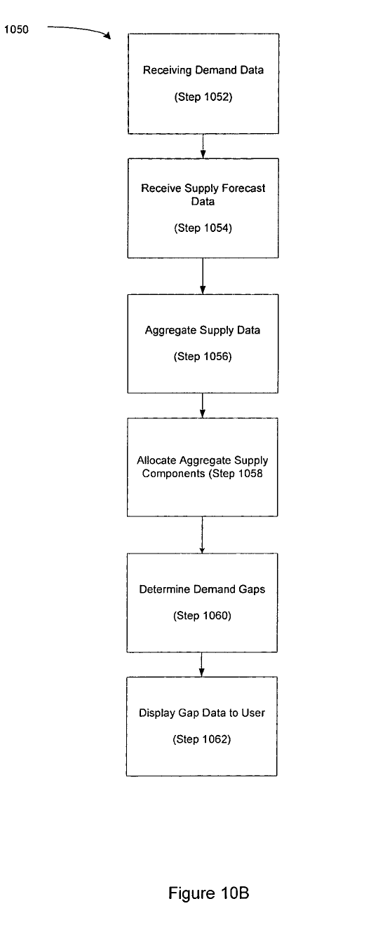

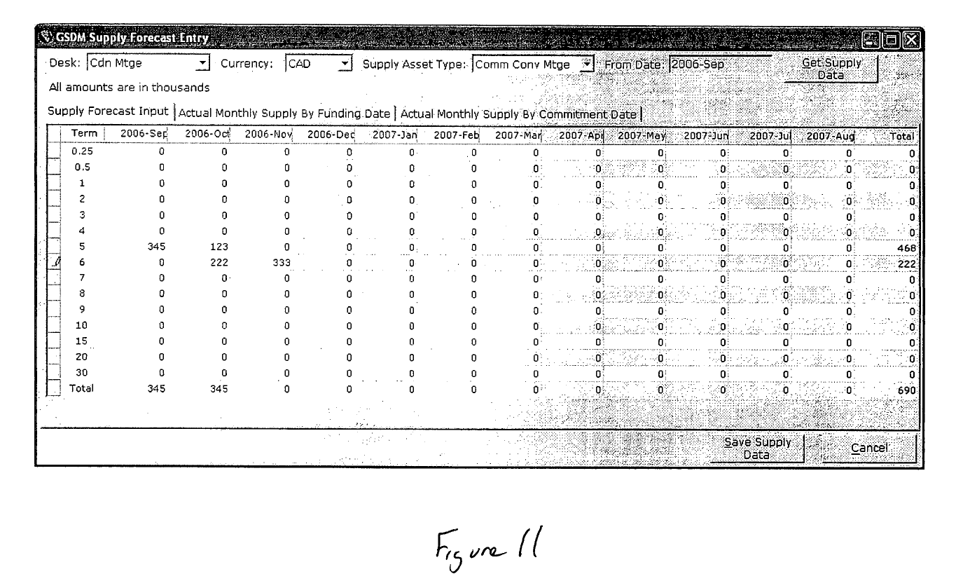

The system 100 is capable of generating two types of gap forecasting reports: a company-wide gap forecast report and a liability segment gap-forecast report. FIG. 10A is a flowchart of a method 1000 of generating a company-wide gap forecast, according to an illustrative embodiment of the invention. The method begins with receiving demand data for liability segments for a future period (step 1001) broken down by asset type, term, and target fill date. Demand data is received via data feed, such as demand data feed 106, or by manual entry through the graphical user interface 132. The received demand data is stored in the demand tables 204 of the database 124. Next, the demand data is aggregated across liability segments for each asset type and term (step 1002), resulting in total demand values. Demand is further broken down by month (step 1003). In determining the demand for a given month, the demand is set to equal the sum of demands of that month and prior months beginning from a user selected date. If the total demand for a period or the calculated sum is negative, the demand for the month is set to zero. In addition, if the sum exceeds the calculated total demand, the demand for a month is capped at the total demand for the period. In alternative embodiments, demand data is received already broken down by month.

Then, supply forecast data is received (step 1004). The supply forecast data can be received via one or more data feeds, such as supply forecast data feed 111, or it may be entered manually through the graphical user interface 132, using a Supply Forecast Input screen (FIG. 11). The received data is stored in the gap forecast tables 214 of the database 124. The supply forecast data includes expected investment opportunities, broken down by asset type, term and month. In one embodiment, the supply data is received independently from each asset origination group in the company. Preferably, supply forecast data is received for at least next six months. In one embodiment, supply forecast data is received for the next twelve months. In still other embodiments, supply forecast data is received for more than a year.

The supply data is then aggregated (step 1006), for example, across asset origination groups. As indicated above, in one embodiment, the classification of investment opportunities into asset types is more granular than the classification of investment demand. Thus, in this embodiment, the supply data is also aggregated by asset type to match the asset types used to classify investment demand.

After investment supply is aggregated, the “gap” is determined for each asset type, term, and month (step 1008). The gap for each asset type, term, and target fill month is calculated (step 1008) based on the aggregate investment demand and aggregate investment supply values. The gap data can then be output to a user, for example, by displaying it via the graphical user interface 132, exporting it to another application, or by printing it (step 1012). In one embodiment, the gap data is sorted by gap size or by asset type.

FIG. 10B is a flow chart of method 1050 of generating a liability-segment gap forecast report according to an illustrative embodiment of the invention. The method begins with receiving demand data for liability segments for a future period (step 1052) broken down by asset type, term, and target fill date. Demand data is received via data feed, such as demand data feed 106, or by manual entry through the graphical user interface 132. The received demand data is stored in the demand tables 204 of the database 124.

Then, supply forecast data is received (step 1054). The supply forecast data can be received via one or more data feeds, such as supply forecast data feed 111, or it may be entered manually through the graphical user interface 132, using a Supply Forecast Input screen (FIG. 11). The received data is stored in the gap forecast tables 214 of the database 124. The supply forecast data includes expected investment opportunities, broken down by asset type, term and month. In one embodiment, the supply data is received independently from each asset origination group. Preferably, supply forecast data is received for at least next six months. In one embodiment, supply forecast data is received for the next twelve months. In still other embodiments, supply forecast data is received for more than a year.

The supply data is then aggregated (step 1056), for example, across asset origination group. As indicated above, in one embodiment, the classification of investment opportunities into asset types is more granular than the classification of investment demand. Thus, in this embodiment, the supply data is also aggregated by asset type to match the asset types used to classify investment demand. Each aggregated amount corresponding to a combination of asset type, term, and fill-month is referred to herein as a “supply component”.

After investment supply is aggregated, the supply components that make up the investment supply are allocated among the liability segments of the company (step 1058). A supply component can be allocated to a liability segment in a similar fashion as an individual investment opportunity is allocated to a individual demand component. However, as the allocation is of aggregate supply amounts, as opposed to individual investment opportunities, constraints related to the allocation of an individual investment opportunity are ignored. Such constraints include, for example, the maximum and minimum amounts allowed to be allocated to a particular liability segment and the maximum or minimum number of liability segments to which a particular investment opportunity can be located. Allocation among liability segments may be based on priorities assigned to the liability segments, relative investment demands of the liability segments, and/or return on capital considerations.

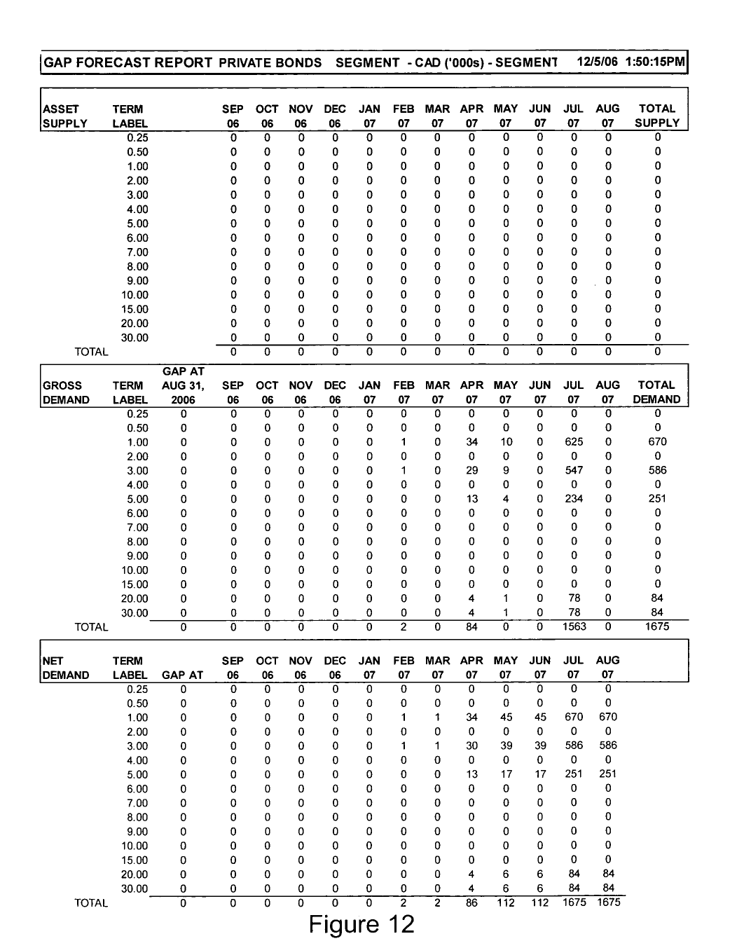

After the investment supply is allocated (step 1058) demand gaps are determined for each liability segment for each asset type, term, and target fill month (step 1060). The gap for a particular combination of attributes for a liability segment is determined to be the difference between the liability segment's investment demand for investment opportunities having those attributes and the amount of the aggregated investment supply having those attributes that was allocated to the liability segment. The gap data can then be output to a user, for example, by displaying it via the graphical user interface 132, exporting it to another application, or by printing it (step 1062). In one embodiment, the gap data is sorted by gap size or by asset type. In one embodiment, the company-wide and liability segment gap analyses are combined in a single process, yielding a single gap forecast report. An example of a printed gap forecast report is shown in FIG. 12.

In other embodiments, multiple sets of investment demand, investment supply, their probabilities and correlation factors are used to perform scenario analysis and derive expected value and probability distributions of the gap for given planning horizon.

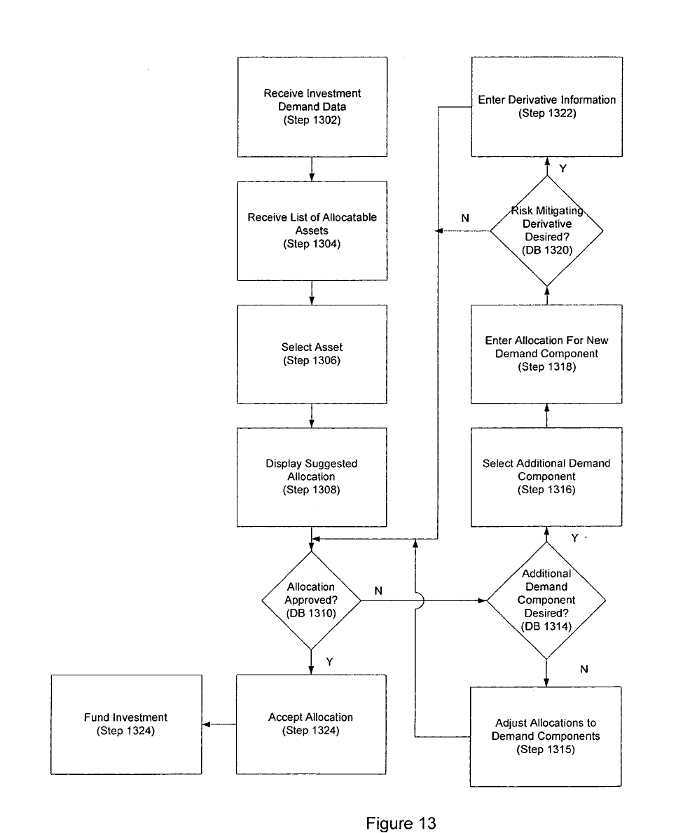

FIG. 13 is a flow chart of a method 1300 of allocating investment opportunities using the system 100, according to an illustrative embodiment of the invention. In particular, the method 1300 begins with the receipt of investment demand data for liability segments of a financial services company (step 1302). The demand data is stored in the demand table 204 of the database 124. A list of allocatable investment opportunities is then received (step 1304) and is stored in the supply table 202 of the database 124. The investment opportunities, in one implementation, include investment opportunities that are yet to be funded. For example, they are currently being negotiated, or they recently have been approved, but have not yet been funded. Such yet to be funded investment opportunities may be allocated months or even years prior to completion or closing of the investment opportunity. One of the investment opportunities is then selected for allocation (step 1306), for example, from the supply list page 400 using the graphical user interface 132. A computer-generated suggested allocation is output to a user (step 1308), for example, by being displayed via the graphical user interface 132. The suggested allocation indicates a division of the investment opportunity among a set of eligible demand components of the financial services company, corresponding to different liability segments and different portfolios maintained by those segments. If the user approves of the allocation (decision block 1310), the user can accept the suggested allocation (step 1312). The allocation is then stored in the allocation table 208. Otherwise, the user can manually adjust the allocation.

To manually adjust the allocation, the user determines whether additional demand components are desired among which to allocate the investment opportunity (decision block 1314). If the user decides to reallocate the investment opportunity among the suggested demand components without adding a new demand component, the user manually readjusts the allocations to the suggested set of demand components (step 1315), using, for example, the allocation page 700 via the graphical user interface 132. If an additional demand component is desired, the user selects the additional demand component from a list of demand components (step 1316). The list of demand components may, in one implementation, include demand components associated with third party entities that are not part of the financial services company. After selection of the additional demand component (step 1316), the user enters an allocation to the demand component (step 1318). If the purchase of a derivate contract is desired to mitigate the risk of an allocation to a particular demand component, the user enters information about the derivate contract into the system (step 1322). For example, if an additional demand component selected to allocate an investment opportunity to is based on a currency other than the currency on which the investment opportunity is based (decision block 1320), a user may input a purchase of a currency swap to address the potential for future currency fluctuations. This can be done using the swap info page 800 displayed by the graphical user interface 132. The user can then continue with the manual reallocation process at decision block 1314. After the user is satisfied with the allocation, the user accepts the allocation at step 1312, storing the allocation in the allocation tables 208. Thereafter, upon the funding date of the investment opportunity, the liability segments corresponding to the demand components among which the investment opportunity was allocated fund the investment opportunity (step 1324) according to the allocation.

The invention may be embodied in other specific forms without departing from the spirit or essential characteristics thereof. The forgoing embodiments are therefore to be considered in all respects illustrative, rather than limiting of the invention.

What is claimed is:

1. A system for managing investment supply and investment demand of a company comprising:
at least one of an allocation computer-implemented process for outputting a suggested allocation of a yet to be funded investment opportunity among a first plurality of segments of a company and a gap forecasting computer-implemented process for forecasting future differences in expected investment supply and expected investment demand for a second plurality of segments of the company;
at least one of a deal analysis computer-implemented process for outputting a comparison of a proposed investment opportunity to be originated by the company with data to determine the relative value of the investment and an asset mix reporting computer-implemented process for comparing an actual asset mix of a segment of the company to a target asset mix for the segment; and
a common graphical user interface computer-implemented process for selecting activation of and for interacting with the computer-implemented processes.

2. The system of claim 1, comprising a common database shared among the computer-implemented processes.

3. A system for allocating a yet to be funded investment opportunity among a plurality of segments of a company comprising:
a database for storing
investment demand data for each of the plurality of segments, and
allocation constraints associated with at least one of a set of demand components, specified investment opportunities, and groups of investment opportunities,
wherein at least a subset of the demand components corresponds to at least one of the segments;
an allocation program operating on a processor for
identifying a set of demand components to which the yet to be funded investment opportunity is to be allocated based at least in part on the demand data stored in the database, and
determining a suggested allocation of the yet to be funded investment opportunity among the demand components based at least in part on the allocation constraints; and
a graphical user interface for outputting the suggested allocation to a user.

4. The system of claim 3, wherein the allocation program stores an actual allocation of the investment opportunity to the database.

5. The system of claim 3, wherein the yet to be funded investment opportunity is originated by the company.

6. The system of claim 3, wherein the set of demand components includes demand components having an asset type that corresponds to the asset type of the yet to be funded investment opportunity.

7. The system of claim 3, wherein the set of demand components includes demand components with terms that correspond to the term of the yet to be funded investment opportunity.

8. The system of claim 7, wherein the term of the yet to be funded investment opportunity considered by the allocation computer-implemented process in identifying demand components is an average life value equal to a weighted average time to the receipt of all future cash flows of the yet to be funded investment opportunity.

9. The system of claim 7, wherein the term of the yet to be funded investment opportunity considered by the allocation computer-implemented process in identifying demand components is a time to maturity of the yet to be funded investment opportunity.

10. The system of claim 7, wherein in identifying the set of demand components, the allocation program compares the term of the yet to be funded investment opportunity to terms and term tolerances associated with the demand components.

11. The system of claim 3, wherein the set of demand components includes only demand components having minimum rating requirements that a rating of the yet to be funded investment opportunity meets or exceeds.

12. The system of claim 3, wherein the set of demand components includes only demand components having minimum spread requirements that a spread of the yet to be funded investment opportunity meets or exceeds.

13. The system of claim 3, wherein allocating the yet to be funded investment opportunity comprises allocating the yet to be funded investment opportunity among a plurality of demand components in the set of demand components based on the relative demands of the each of the plurality of demand components.

14. The system of claim 13, wherein the plurality of demand components are selected based on priorities assigned to each of the demand components in the set of the demand components.

15. The system of claim 3, wherein allocating the yet to be funded investment opportunity among the set of demand components comprises allocating the yet to be funded investment opportunity based at least in part on a priority assigned to each demand component.

16. The system of claim 3, wherein the graphical user interface accepts input from a user of an alternative allocation of the yet to be funded investment opportunity.

17. The system of claim 3, comprising a data feed process for accepting a data feed including data about new investment opportunities.

18. The system of claim 3, comprising a data feed process for accepting a data feed including data about company segment demand.

19. The system of claim 3, wherein the yet to be funded investment opportunity is based on a first currency and at least one of the demand components in the set of demand components is based on a different currency.

20. The system of claim 3; wherein the yet to be funded investment opportunity is originated in a first country and the at least one of the demand components in the set of demand components includes liabilities originated in a different country.

21. The system of claim 3, wherein the yet to be funded investment opportunity comprises one of a mortgage and private debt.

22. A computer-implemented method for allocating a yet to be funded investment opportunity among a plurality of segments of a company comprising:
receiving investment demand data for each of the plurality of segments;
identifying a set of demand components to which the yet to be funded investment opportunity is to be allocated based at least in part on the received demand data, wherein at least a subset of the demand components corresponds to at least one of the segments;
determining a suggested allocation of the yet to be funded investment opportunity among the demand components based at least in part on allocation constraints associated with at least one of a set of demand components and the yet to be funded investment opportunity; and
outputting the suggested allocation to a user.

23. The computer-implemented method of claim 22, comprising storing an actual allocation of the yet to be funded investment opportunity.

24. The computer-implemented method of claim 23, comprising allocating funds to the yet to be funded investment opportunity according to the stored actual allocation.

25. The computer-implemented method of claim 22, comprising originating, by the company, the yet to be funded investment opportunity.

26. The computer-implemented method of claim 22, wherein identifying the set of demand components comprises identifying demand components having an asset type that corresponds to an asset type of the yet to be funded investment opportunity.

27. The computer-implemented method of claim 22, wherein identifying the set of demand components comprises identifying demand components with terms that correspond to a term of the yet to be funded investment opportunity.

28. The computer-implemented method of claim 27, wherein the term of the yet to be funded investment opportunity considered in identifying demand components is an average life value equal to a weighted average time to the receipt of all future cash flows of the yet to be funded investment opportunity.

29. The computer-implemented method of claim 27, wherein the term of the yet to be funded investment opportunity considered in identifying demand components is a time to maturity of the yet to be funded investment opportunity.

30. The computer-implemented method of claim 27, wherein identifying the set of demand components comprises comparing the term of the yet to be funded investment opportunity to terms and term tolerances associated with the demand components.

31. The computer-implemented method of claim 22, wherein identifying the set of demand components includes identifying demand components that have minimum rating requirements that a rating of the yet to be funded investment opportunity meets or exceeds.

32. The system of claim 22, wherein identifying the set demand components includes identifying demand components that have minimum spread requirements that a spread of the yet to be funded investment opportunity meets or exceeds.

33. The computer-implemented method of claim 22, wherein determining the suggested allocation comprises allocating the yet to be funded investment opportunity among a plurality of demand components in the set of demand components based on relative demands of the each of the plurality of demand components.

34. The computer-implemented method of claim 33, wherein the plurality of demand components are selected based on priorities assigned to each of the demand components in the set of the demand components.

35. The computer-implemented method of claim 22, wherein determining the suggested allocation comprises allocating the yet to be funded investment opportunity among the set of demand components based at least in part on a priority assigned to each demand component.

36. The computer-implemented method of claim 22, comprising accepting input from a user of an alternative allocation of the yet to be funded investment opportunity.

37. The computer-implemented method of claim 22, comprising accepting a data feed including data about new investment opportunities.

38. The computer-implemented method of claim 22, comprising accepting a data feed including data about company segment demand.

39. The computer-implemented method of claim 22, wherein the yet to be funded investment opportunity is based on a first currency and at least one of the demand components in the set of demand components is based on a different currency.

40. The computer-implemented method of claim 22, wherein the yet to be funded investment opportunity originates in a first country and the at least one of the demand components in the set of demand components includes liabilities originated in a different country.

41. The computer-implemented method of claim 22, wherein the yet to be funded investment opportunity comprises one of a mortgage and private debt.

42. A computer readable medium encoding instructions for causing a computer to carry out a method for allocating a yet to be funded investment opportunity among a plurality of segments of a company comprising:
receiving investment demand data for each of the plurality of segments;
identifying a set of demand components to which the yet to be funded investment opportunity is to be allocated based at least in part on the received demand data, wherein at least a subset of the demand components corresponds to at least one of the segments;
determining a suggested allocation of the yet to be funded investment opportunity among the demand components based at least in part on allocation constraints associated with at least one of a set of demand components and the yet to be funded investment opportunity; and
outputting the suggested allocation to a user.

43. The computer readable medium of claim 42, comprising instructions for causing a computer to store an actual allocation of the yet to be funded investment opportunity.

44. The computer readable medium of claim 43, comprising instructions for causing a computer to allocating funds to the yet to be funded investment opportunity according to the stored actual allocation.

45. The computer readable medium of claim 42, wherein the yet to be funded investment opportunity is originated by the company.

46. The computer readable medium of claim 42, wherein the instructions for identifying the set of demand components comprise instructions for causing a computer to identify demand components having an asset type that corresponds to an asset type of the yet to be funded investment opportunity.

47. The computer readable medium of claim 42, wherein the instructions for identifying the set of demand components comprise instructions for causing a computer to identify demand components with terms that correspond to a term of the yet to be funded investment opportunity.

48. The computer readable medium of claim 47; wherein the term of the yet to be funded investment opportunity considered in identifying demand components is an average life value equal to a weighted average time to the receipt of all future cash flows of the yet to be funded investment opportunity.

49. The computer readable medium of claim 47, wherein the term of the yet to be funded investment opportunity considered in identifying demand components is a time to maturity of the yet to be funded investment opportunity.

50. The computer readable medium of claim 47, wherein the instructions for identifying the set of demand components comprise instructions for causing a computer to compare the term of the yet to be funded investment opportunity to terms and term tolerances associated with the demand components.

51. The computer readable medium of claim 42, wherein the instructions for identifying the set of demand components comprise instructions for causing a computer to identify demand components that have minimum rating requirements that a rating of the yet to be funded investment opportunity meets or exceeds.

52. The computer readable medium of claim 42, wherein the instructions for identifying the set of demand components comprise instructions for causing a computer to identify demand components that have minimum spread requirements that a spread of the yet to be funded investment opportunity meets or exceeds.

53. The computer readable medium of claim 42, wherein the instructions for determining the suggested allocation comprise instructions for causing a computer to allocate the yet to be funded investment opportunity among a plurality of demand components in the set of demand components based on the relative demands of the each of the plurality of demand components.

54. The computer readable medium of claim 53, wherein the plurality of demand components are selected based on priorities assigned to each of the demand components in the set of the demand components.

55. The computer readable medium of claim 42, wherein the instructions for determining the suggested allocation comprise instructions for causing a computer to allocate the yet to be funded investment opportunity among the set of demand components based at least in part on a priority assigned to each demand component.

56. The computer readable medium of claim 42, encoding instructions for causing a computer to accept input from a user of an alternative allocation of the yet to be funded investment opportunity.

57. The computer readable medium of claim 42, encoding instructions for causing a computer to accept a data feed including data about new investment opportunities.

58. The computer readable medium of claim 42, encoding instructions for causing a computer accept a data feed including data about company segment demand.

59. The computer readable medium of claim 42, wherein the yet to be funded investment opportunity is based on a first currency and at least one of the demand components in the set of demand components is based on a different currency.

60. The computer readable medium of claim 42, wherein the yet to be funded investment opportunity originates in a first country and the at least one of the demand components in the set of demand components includes liabilities originated in a different country.

61. The computer readable medium of claim 42, wherein the yet to be funded investment opportunity comprises one of a mortgage and private debt.

62. A computer-implemented method for allocating a forecasted investment supply among a plurality of segments of a company comprising:
receiving investment demand data for each of the plurality of segments;
identifying a set of demand components to which the forecasted investment supply is to be allocated based at least in part on the received demand data, wherein at least a subset of the demand components corresponds to at least one of the segments;
determining a projected allocation of the forecasted investment supply among the demand components based at least in part on allocation constraints;
outputting a projected set of investment demand gaps, for at least one of the plurality of segments.

63. The computer-implemented method of claim 62, wherein the forecasted investment supply comprises a forecasted aggregate amount of future investment opportunities.

64. The computer-implemented method of claim 63, wherein a demand gap for a segment comprises a difference between a projected allocation to the segment and investment demand for the segment at a particular time.

65. The computer implemented method of claim 62, comprising:
receiving alternative demand data for each of the plurality of segments;
determining an alternative projected allocation of the forecasted investment supply among the demand components; and
outputting an alternative projected set of demand gaps.

66. The computer implemented method of claim 65, comprising outputting probabilities of each of the demand gaps and the alternative demand gaps.

67. The computer implemented method of claim 65, comprising receiving probabilities associated with the demand data and the alternative demand data.

68. The computer implemented method of claim 62, comprising:
receiving alternative forecasted supply data;
determining an alternative projected allocation of the alternative forecasted investment supply among the demand components; and
outputting an alternative projected set of demand gaps.

69. The computer implemented method of claim 68, comprising outputting probabilities of each of the demand gaps and the alternative demand gaps.

70. The computer implemented method of claim 68, comprising receiving probabilities associated with the forecasted investment supply data and the alternative forecasted supply data.
